(19) United States
(12) Patent Application Publication
(10) Pub. No.: US 2023/0342622 A1
(43) Pub. Date: Oct. 26, 2023

(54) Methods and Systems for Detecting Causes of Observed Outlier Data

(71) Applicant: RYLTI,LLC, Woodbury, NY (US)

(72) Inventors: Peter J. FIORILLO, Woodbury, NY (US); Joseph GLICK, Woodbury, NY (US)

(21) Appl. No.: 18/305,969

(22) Filed: Apr. 24, 2023

Related U.S. Application Data
(60) Provisional application No. 63/334,527, filed on Apr. 25, 2022.

(51) Int. Cl. G06F 9/54; G06N 3/091

(52) U.S. Cl. CPC G06N 3/091; G06F 9/542

(57) ABSTRACT

A method for automatically detecting causes of outlier data-event scenarios. A plurality of linksets of an ontological model are instantiated in an in-memory neural network. The instantiated linksets are a tailored array of interconnected index tables that defines the ontological relationship between potential causes, parameters, data-event attributes corresponding to the parameters, and neutrosophic rules corresponding to the potential causes and the parameters. Data-events are indexed so as to generate an index class that links each indexed data-event to the instantiated data-event attributes corresponding to the instantiated parameters via corresponding attribute values of the indexed data-events. The index class is supplemented with additional data-event attributes corresponding to repeating attribute values of the indexed data-events. The index class is neutrosophically analyzed according to the neutrosophic rules of the instantiated linkset, so as to detect whether certain combinations of data-event attributes are likely caused by the potential causes.

### CROSS-REFERENCE TO RELATED APPLICATIONS

This application claims the benefit of U.S. Provisional Application No. 63/334,527, filed Apr. 25, 2022, the disclosures of which are expressly incorporated by reference herein.

### BACKGROUND

The disclosed invention is related to methods and system for detecting potential causes of observed outlier scenarios in big data sets.

In the field of artificial intelligence, researchers typically must train artificial neural networks on hundreds to thousands of examples of a specific pattern or concept before the artificial synapse strengths adjust enough for the neural network to have “learned” that pattern or concept. Such systems are not currently able to carry their experiences from one set of circumstances to another — leading to the necessity of training new models for pattern recognizing new scenarios, even if those new scenarios are similar to those recognized via prior models. Such systems are indeed incapable of identifying new scenarios at all, without human intervention and substantial retraining.

There is also an increasing lag between the ability to generate big data and to analyze it. This lag is further increased by the necessity of human retraining of the artificial intelligence models used in such analysis. Moreover, that retraining requires first that humans recognize the need for training new models. In other words, humans must first recognize that the current A.I. models are not recognizing a new pattern corresponding to a new scenario, before a new model can be trained to recognize it.

It is for at least this reason that true causality determination - i.e., the ability to identify new scenarios that may correspond to an existing model — has evaded the field of artificial intelligence. Systems and methods that overcome these shortcomings are desirable, particularly in the fields where the analysis of big data is required to identify potential causes of outlier scenarios.

### BRIEF DESCRIPTION OF DRAWINGS

FIG. 1 is a schematic representation of an exemplary system for automatically detecting causes of outlier data-event scenarios, according to one or more embodiments.

FIG. 2 is schematic representation of an exemplary causality platform architecture, according to one or more embodiments.

FIG. 3 is a schematic representation of an exemplary ontological model, according to one or more embodiments.

FIG. 4 is a schematic representation of an exemplary coincidence table, according to one or more embodiments.

FIG. 5 is a schematic representation of an exemplary tailored linkset, according to one or more embodiments.

FIG. 6 is a schematic representation of exemplary mapping so as to generate an index class, according to one or more embodiments.

FIG. 7 is a schematic representation of an exemplary generation of a detail class, according to one or more embodiments.

FIG. 8 is schematic representation of an exemplary generation of a computed class, according to one or more embodiments.

FIG. 9 is schematic representation of an exemplary generation of multi-level data-event outlier scenarios, according to one or more embodiments.

### DESCRIPTION OF EMBODIMENTS

In the following description, for purposes of explanation, numerous specific details are set forth in order to provide a thorough understanding of the disclosed concepts. As part of this description, some of this disclosure’s drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure’s drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers’ specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of entity resolution having the benefit of this disclosure.

As used herein, the term “computer system” can refer to a single programmable device or a plurality of programmable devices working together to perform the function described as being performed on or by the computer system.

As used herein, the term “medium” refers to a single physical medium or a plurality of media that together store what is described as being stored on the medium.

As used herein, the term “network device” can refer to any programmable device that is capable of communicating with another programmable device across any type of network.

Persons of ordinary skill in the art are aware that software programs may be developed, encoded, and compiled in a variety of computing languages for a variety of software platforms and/or operating systems and subsequently loaded and executed by one or more processors (and/or other networked components) so as to enable the functions disclosed herein. The compiling of such software programs may transform program code written in a programming language to another computer language such that the processor(s) are able to execute the programming code. For example, the compiling process of the software program may generate an executable program that provides encoded instructions (e.g., machine code instructions) for the processor(s) to accomplish specific, non-generic, particular computing functions. After the compiling process, the encoded instructions may then be loaded as computer executable instructions or process steps to processor and/or embedded within the processor(s) (e.g., as a cache). The processor(s) can execute the stored instructions or process steps in order to perform instructions or process steps to transform the processor into a non-generic, particular, specially programmed machine or apparatus configured to function and/or carry out the processes described herein.

In one or more embodiments, systems and methods for detecting causes of outlier data-event scenarios are disclosed herein. The disclosed embodiments result in several advantages to computer systems that are heretofore unrealized.

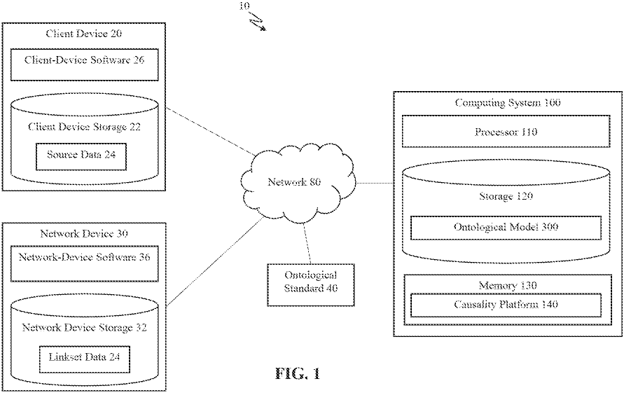

FIG. 1 schematically illustrates a system 10 for automatically detecting causes of outlier data-event scenarios, according to one or more embodiments.

The system 10 includes a computing system 100, on which a causality platform 140 is hosted. The computing system is connected to one or more networked devices, such as a client device 20 and/or a network device 30, across a network 80.

The computing system 100 may be, for example, one or more servers or other computing devices. Further, the computing system 100 may be a distributed network system, such as a network cloud, across which the various components and functionality described within computing system 100 may be distributed.

The computing system 100 may include, for example, a processor 110, a storage 120 and a memory 130. The processor 110 may include a single processor or multiple processors. Further, in one or more embodiments, the processor 110 may include different kinds of processors, such as a central processing unit (“CPU”) and a graphics processing unit (“GPU”).

The memory 130 may be operatively coupled to the processor 110, and may include a number of software or firmware modules executable by processor 110. The memory 130 may be a non-transitory medium configured to store various types of data, including but not limited to processor executable software programs for implementing the functions described herein, and may include a single memory device or multiple memory devices.

For example, memory 130 may include one or more memory devices that comprise a non-volatile storage device and/or volatile memory. Volatile memory, such as random access memory (RAM), can be any suitable non-permanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated volatile memory is not large enough to hold all working data. The non-volatile storage device may also be used to store programs that are loaded into the volatile memory when such programs are selected for execution.

The memory 130 may further include the causality platform 140, which may be a process automation platform that provides automated services for automatically detecting causes of outlier data-event scenarios in one or more industries, e.g., the health care industry, as described further herein. It will be understood that, while the health care industry is described herein as a specific use case, the principles of the invention are applicable to any industry for which the detection of potential causes of outlier data-event scenarios, particularly with regards to big data, is desired.

The storage 120 may include a single storage device, or multiple storage devices also configured to store various types of data and information used in furtherance of executing the functions described herein. The stored data, e.g., data stored by a storage device 120, can be accessed by the processor 110 during the execution of computer executable instructions or process steps, in accordance with one or more processor executable software programs for implementing the functions described herein.

The client device 20 may include any kind of computing device accessible across network 80, with which computing system 100 may communicate data and information in furtherance of the functions described herein. For example, the client device 20 may be an additional computing system, a server, a remote computer, or the like, which may be controlled by the same or different entity as computing system 100 and/or any of the networked devices.

The client device 20 may include a client-side software application 26 configured to provide some or all of the functionality described herein, including but not limited to communicating data and instructions to and/or from the computing system 100. Further, the client-side software application 26 may provide an interface such that a user of client device 20 may utilize the various components and functionality of computing system 100. A user interface can include a display, positional input device (such as a mouse, touchpad, touchscreen, or the like), keyboard, or other forms of user input and output devices. When the output device is or includes a display, the display can be implemented in various ways, including by a liquid crystal display (LCD) or a cathode-ray tube (CRT) or light emitting diode (LED) display, such as an OLED display.

The client device 20 may further include a client storage 22 configured to store data and information used in furtherance of the functions described herein. The client storage 22 may be a non-transitory medium configured to store various types of data and information. For example, client storage 22 may include one or more memory devices that comprise a non-volatile storage device and/or volatile memory.

The client storage 22 may, for example, store source data 24 therein. The source data 24 may be a record of data-events and corresponding attribute values for one or more data-event attributes, which record may be generated and/or maintained by a client computer system (not shown). The source data 24 may be generated in accordance with the industry, client or system ontological standard 40 that defines the data-event attributes and permissible attribute values thereof for characterizing the data-events.

The network device 30 may include any kind of computing device accessible across network 80, with which computing system 100 may communicate, and which may provide relevant data, such as linkset data 34 from a network device storage 32. For example, the network device 20 may be an additional computing system, a server, a remote computer, or the like. Further, the network device 20 may be controlled by the same or different entity as computing system 100 and/or any of the networked devices.

The network device 30 may include any kind of computing device accessible across network 80, with which computing system 100 may communicate data and information in furtherance of the functions described herein. For example, the network device 30 may be an additional computing system, a server, a remote computer, or the like, which may be controlled by the same or different entity as computing system 100 and/or any of the networked devices.

The network device 30 may include a network-device software application 36 configured to provide some or all of the functionality described herein, including but not limited to communicating data and instructions to and/or from the computing system 100. Further, the network-device software application 36 may provide an interface such that a user of network device 20 may utilize the various components and functionality of computing system 100. A user interface can include a display, positional input device (such as a mouse, touchpad, touchscreen, or the like), keyboard, or other forms of user input and output devices. When the output device is or includes a display, the display can be implemented in various ways, including by a liquid crystal display (LCD) or a cathode-ray tube (CRT) or light emitting diode (LED) display, such as an OLED display.

The network device 30 may further include a client storage 32 configured to store data and information used in furtherance of the functions described herein. The network storage 32 may be a non-transitory medium configured to store various types of data and information. For example, network storage 32 may include one or more memory devices that comprise a non-volatile storage device and/or volatile memory.

The network storage 32 may, for example, store linkset data 34 therein. The linkset data 34 may identify one or more potential causes (e.g., fraud, malpractice, etc.) of outlier data-event scenarios, and one or more parameters for defining the outlier data-event scenarios. The linkset data 34 may further identify, for each potential cause: one or more data-event attributes relevant to determining whether the potential cause is likely to cause outlier scenarios, and one or more rules for determining which of the potential causes are likely causes of the outlier scenarios. The linkset data 32 may be generated by subject matter experts in accordance with the industry, client or system ontological standard 40 that defines the data-event attributes and the permissible attribute values thereof.

The network 80 may include one or more different types of wired and/or wireless computer networks, such as the Internet, a corporate network, a Local Area Network (LAN), or a personal network, such as those over a Bluetooth connection. Each of these networks can contain wired or wireless programmable devices and operate using any number of network protocols (e.g., TCP/IP). The network 80 may be operatively connected to gateways and routers, servers, and end user computers, as known in the art, so as to enable the communication data and/or instructions over the network 80.

The causality platform 140 may be hardware and/or software configured to provide automated services for detecting causes of outlier data-event scenarios in one or more industries, e.g., the health care payer industry. The causality platform 140 may therefore comprise one or more software programs or functional modules that perform or otherwise cause the performance of one or more features and aspects described herein.

In at least one embodiment, the causality platform 140 may be configured to utilize neutrosophic processing and/or apply an ontological model 300 to evaluate input source data so as to detect causes of outlier data-event scenarios from the input source data. Such evaluation of the input source data is referred to herein as automated causality detection.

The ontological model may comprise one or more linksets, each of which may be a segmented data architecture comprising an array of interconnected index tables, where each indexed object has specifically associated vector values. Accordingly, the ontological model may be generated from linkset data, in accordance with the industry, client or system ontological standard 40.

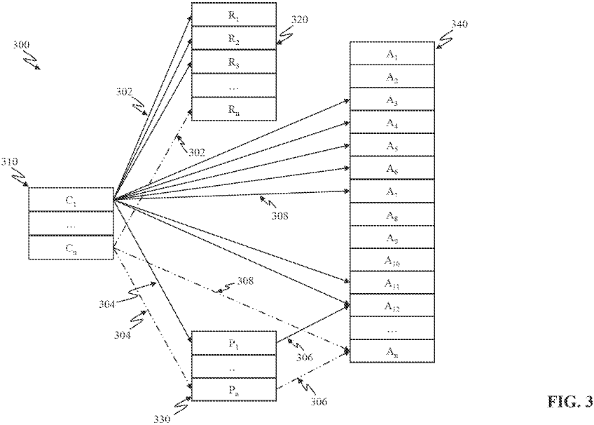

FIG. 3 illustrates an exemplary ontological model 300, comprising a potential cause index table 310, a rules index table 320, a parameter index table 330 and a data-event attribute index table 340.

The potential cause index table 310 includes one or more index objects representing potential causes Cₙ of outlier data-event scenarios. For example, potential causes Cₙ of outlier data-event scenarios in the health care payer industry may include: fraud, malpractice, coding error, payment policy error, incorrect diagnosis, incorrect procedure, incorrect drug, incorrect patient, incorrect charge, duplicate charge, duplicate claim, duplicated treatment protocols, etc. The index objects representing the potential causes Cₙ are referred to herein, for simplicity, as simply the potential causes Cₙ.

Each potential cause Cₙ may be linked, via specifically associated vector values, to one or more neutrosophic rules Rₙof the rules index table 320, to one or more parameters Pₙ of the parameter index table 330, and/or to one or more data-event attributes Aₙ of the data-event attribute table 340.

The rules index table 320 includes one or more index objects representing neutrosophic rules Rₙ for truth determinacy with respect to linked potential causes Cₙ. For example, each Rₙ may represent a rule to evaluate one or more data-event attributes and/or data-event scenarios for occurrence rates of common attribute values with respect to one or more respective thresholds. The rule R₁ may, for example, cause the evaluation of data-event attributes for occurrence rates of common attribute values greater than or equal to 75%, whereas the rule R₂ may cause the evaluation of data-event attributes for occurrence rates of common attribute values between 25%-74%, and the rule R₃ may cause the evaluation of data-event attributes for occurrence rates of common attribute values less than 25%. The index objects representing the neutrosophic rules Rₙ are referred to herein, for simplicity, as the rules Rₙ.

Each rule Rₙ may be linked, via specifically associated vector values 302, to one or more potential cause Cₙ. Moreover, each potential cause Cₙ may be linked to the rule or rules Rₙ that are relevant to the automated causality detection for that potential cause Cₙ.

The parameter index table 330 includes one or more index objects representing parameters Pₙ for defining outlier data-event scenarios with respect to linked potential causes Cₙ. For example, Pₙ may reflect parameters for defining the outlier data-event scenarios for which the causality platform is to detect causes for. The parameters Pₙ may generally include one or more attribute value thresholds, ranges, rules or other boundary conditions, that data-events must satisfy in order to be considered an outlier data-event scenario. For example, parameter P₁ may require that outlier data-event scenarios have attribute values for data-event attribute A₁₂ (e.g., CHARGE_AMT) that exceeds some value threshold (e.g., $2,000). The index objects representing the parameters Pₙ are referred to herein, for simplicity, as the parameters Pₙ.

Each parameter Pₙ may be linked, via specifically associated vector values 304, to one or more potential cause Cₙ, as well as, via specifically associated vector values 306, to one or more data-event attributes Aₙ. Moreover, each potential cause Cₙ may be linked to the parameter or parameters Pₙ that are relevant to the automated causality detection for that potential cause Cₙ. Similarly, each parameter Pₙ may be linked to the data-event attributes Aₙ that are relevant to determining the satisfaction of that parameter Pₙ.

The data-event attribute index table 340 includes one or more index objects representing data-event attributes Aₙ via which data-events may be defined, in accordance with the ontological standard 40. For example, data-event attribute A₁ may be EMP_PLAN_ID; data-event attribute A₂ may be PT_SX; data-event attribute A₃ may be PROV_NAME; data-event attribute A₄ may be PROV_TYPE_CODE; data-event attribute Aₛ may be PROV_SPECIALTY; data-event attribute A₆ may be POS_DESC; data-event attribute A₇ may be DIAG_1; data-event attribute A₈ may be DIAG_1_DESC; data-event attribute A₉ may be PROC_CODE; data-event attribute A₁₀ may be PROC_DESC; data-event attribute A₁₁ may be DRG; data-event attribute A₁₂ may be CHARGE_AMT. The index objects representing the data-event attributes Aₙ are referred to herein, for simplicity, as the data-event attributes Aₙ.

Each potential cause Cₙ may be linked, via specifically associated vector values 308, to one or more data-event attributes Aₙ. Moreover, each potential cause Cₙ may be linked to the data-event attribute or attributes Aₙ that are relevant to the automated causality detection for that potential cause Cₙ. Accordingly, each linkset may reflect the ontological relationships between potential causes Cₙ,, parameters Pₙ, and data-event attributes Aₙ contained in the ontological model.

In FIG. 3, a specific linkset is shown schematically as the solid arrows linking the specifically numbered index objects, while a generic linkset is shown schematically as the dashed arrows linking the generic index boxes. It will be understood, however, that the ontological model shown in FIG. 3 is highly simplified for ease of illustrating the principles described herein. In actual operation, the ontological model 300 may include an arbitrarily large number of potential causes Cₙ, rules Rₙ, parameters Pₙ and data-event attributes Aₙ.

Moreover, in some embodiments, subject matter experts may establish and/or link the potential causes Cₙ, rules Rₙ, parameters Pₙ and/or data-event attributes Aₙ via accessing the computing system through the network-device software application 36. The linking may be so as to establish and/or maintain the relevancy of such linking within linksets. Accordingly, the network-device software application 36 provides for the ability to generate and/or otherwise maintain the ontological model 300, particularly with respect to changes to the ontological standard 40 and/or subject matter expert understanding of the relationships between and among the potential causes Cₙ, rules Rₙ, parameters Pₙ and/or data-event attributes Aₙ, as well as further potential causes, rules, parameters and/or data-event attributes.

As discussed herein, the causality platform 140 may be configured to evaluate input source data 24 so as to detect causes of outlier data-event scenarios from the input source data 24, which may reflect one or more data-events. The source data 24 may characterize the data-events in terms of the data-event attributes. In other words, a given data-event may be characterized by its attribute values for the data-event attributes. The source data 24 may be generated in accordance with the industry, client or system ontological standard 40 that defines the data-event attributes and permissible attribute values thereof for characterizing the data-events.

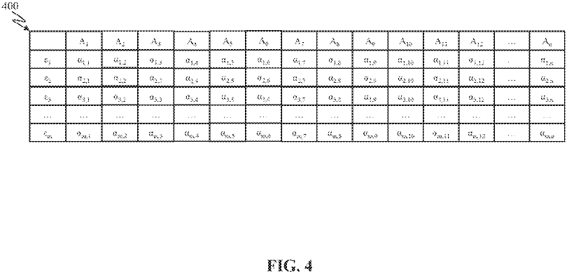

In at least one embodiment, the source data 22 may comprise a coincidence table. An exemplary coincidence table 400 is shown in FIG. 4.

As shown, the coincidence table 400 may comprise one or more data-events ɛₘ characterized by attribute values α_{m,n} for one or more data-event attributes Aₙ. The data-event ɛₘ may further be associated with a unique identifier ɛₘ via the coincidence table 400. For simplicity, the data-event and its unique identifier are referred to herein as the data-event εₘ.

Accordingly, each data-event ɛₘ may be characterized by its corresponding combination of attribute values α_{m,n}, such that data-event ɛₘ is characterized by the set of attribute values {α_{m,1}, α_{m,2}, ..., a_{m,n}} for attributes A₁ to Aₙ, respectively. Moreover, set of data-events having one or more common attribute values may correspond to a data-event scenario, as discussed herein.

It will be understood that the coincidence table 400 shown in FIG. 3 is highly simplified for ease of illustrating the principles of the system described herein. In actual operation, the coincidence table 400 is contemplated as a “big-data” record of data-events, such that the coincidence table 400 may include several hundred-thousands of data-events, with several hundreds of attributes, each attribute having up to several thousands of possible attribute values.

As discussed herein, the coincidence table 400 may be generated and/or maintained by the client computer system (not shown). The client computer system may, for example, be an enterprise-IT computer system of a health care industry payer, i.e., an organization that pays for administered medical services, such as a health insurance plan provider. The computer systems of a health care industry payer generally maintain records of payments made for medical services (i.e., the data-event) - which records include the attributes of such payments and/or the medical services (i.e., the data-event attributes). Those attributes are generally in accordance with the ontological standard 40 of the National Institute of Health (NIH), i.e., the Unified Medical Language System (UMLS), which defines the attributes and permissible values thereof for characterizing payments made for medical services.

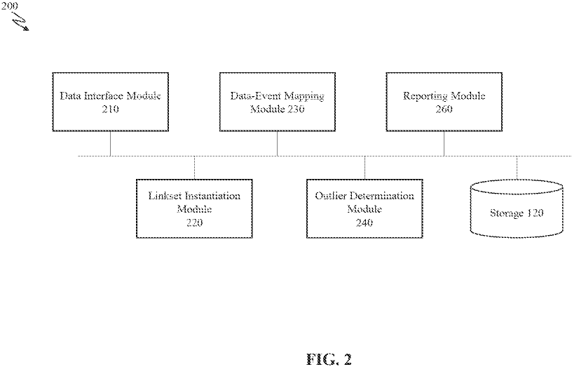

The causality platform 140 may, as discussed, comprise one or more software programs or functional modules that perform or otherwise cause the performance of one or more features and aspects described herein. FIG. 2 schematically illustrates an exemplary causality platform architecture 200 for implementing the functions and/or aspects of the causality platform 140, including automated causality detection.

The causality platform architecture 200 may include a data interface module 210, a linkset instantiation module 220, a data-event mapping module 230, an outlier determination module 240, a neutrosophic processing module 250, and a reporting module 260.

The causality platform may utilize artificial intelligence, for example, in the form of an in-memory neural network to enable the causality platform engage in automated causality detection, as described herein. Accordingly, one or more of the causality platform architecture modules, or of the functions and/or aspects thereof, may be implemented via the in-memory neural network.

The data interface module 210 may be configured to permit bi-directional communication of data and information between the causality platform architecture 200 and one or more external devices, such as the network device 30 and the client device 20.

Accordingly, the data interface module may be configured to receive the linkset data and the source data, as input from the network device 30 and the client device 20, respectively. The source data and the linkset data may be provided contemporaneously or non-contemporaneously with each other, and may further be respectively provided as a single input or as multiple inputs.

The data interface module may be further configured to store the source data and the linkset data in the storage 120 for use by one or of the architecture modules. The source data, in whole or in part, may be stored as the coincidence table 400 and/or updates thereto. The linkset data may be stored, in whole or in part, as one or more linksets of the ontological model 300 and/or updates thereto. In some embodiments, the source data and/or linkset data may be used to generate the coincidence table 400 and/or the ontological model 300.

The data interface module may additionally be configured to receive a user-intent input from the client device 30, which user-intent may identify one or more of the potential causes Cₙ for which the causality platform is to consider in the automated causality detection. In some embodiments, the user-intent may identify a clinical focus for the automated causality detection, which clinical focus may be associated with one or more of the potential causes, such that providing the clinical focus is tantamount to selecting one or more of the potential causes. For example, in the context of the health care industry, the clinical focus of: fee-for-service payments, may implicate the potential cause of: fraud.

The user-intent may further identify one or more of the parameters Pₙ for defining the outlier data-event scenarios to be considered by the automated causality detection, with respect to each identified potential cause Cₙ. For example, the user may only be interested in data-events where the CHARGE_AMT for the fee-for-service payments exceed $2,000.

Accordingly, the user-intent input via the data interface module may define the scope and nature of the automated causality detection to be executed with respect to the input source data.

The linkset instantiation module may be configured to instantiate one or more linksets of the ontological model in the in-memory neural network, based on the user-intent, the ontological model 300, and the source data / coincidence table 400, so as to generate one or more tailored linksets. The tailored linksets may be instantiated in the in-memory neural network.

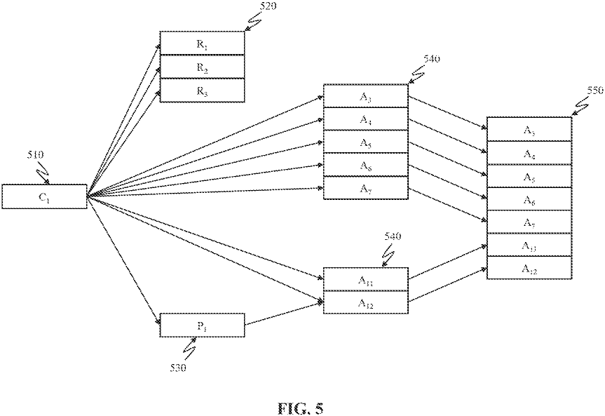

FIG. 5 schematically illustrates a tailored linkset 500 for the identified potential cause C₁ and parameter P₁. The tailored linkset preferably corresponds to the linkset of the ontological model that is associated with the identified potential cause C₁ and parameter P₁. Accordingly, the tailored linkset likewise comprises: a tailored potential cause index table 510, a tailored rules index table 520, a tailored parameter index table 530 and a tailored data-event attribute index table 540.

For example, as shown in FIG. 5, the tailored linkset may include the identified potential cause C₁ (e.g., fraud) and the identified linked parameter P₁ (e.g., CHARGE_AMT > $2,000), as well as the linked data-event attributes A₃ (e.g., PROV_NAME), A₄ (e.g., PROV_TYPE_CODE), A₅ (e.g., PROV_SPECIALTY), A₆ (e.g., POS_DESC), A₇ (e.g., DIAG_1), A₁₁ (e.g., DRG), and A₁₂ (e.g., CHARGE_AMT) and the linked rules R₁ (i.e., occurrence rate ≥ 75%), R₂ (i.e., 75% > occurrence rate ≥ 25%), and R₃ (e.g., occurrence rate < 25%).

The tailored linkset further includes a summary class 550 that includes the linked data-event attributes. The summary class may therefore reflect a subset of event-data attributes with respect to which the source data is to be analyzed via the automated causality detection. In other words, the event-data attributes of the summary class may be those event-data attributes identified by the ontological model as potential neutrosophically dependent variables with respect to the neutrosophically independent variable of the linked possible cause of outlier data-event scenarios.

For example, in the tailored linkset of FIG. 5, the data-event attribute A₆ of POS_DESC is identified via the tailored linkset as potentially indicative, in a fuzzy logic sense, of the potential cause C₁ of fraud for fee-for-service payments over $2,000.

The data-event mapping module may be configured to map the source data to the tailored linkset, so as to generate an index class 620 that may be instantiated in the in-memory neural network. The index class may associate a set of indexed data-events with the event-data attributes of the summary class via their respective attribute values for those event-data attributes.

The data-event mapping module may generate an analysis class 610, which associates the event-data attributes of the summary class with the data-events of the source data that have attribute values for those summary class event-data attributes. The set of data-events that have attribute values for the summary class event-data attributes is referred to herein as the set of indexed data-events, or the indexed data-events. Accordingly, the analysis class identifies the set of indexed data-events, from the source data, to be considered via the automated causality detection.

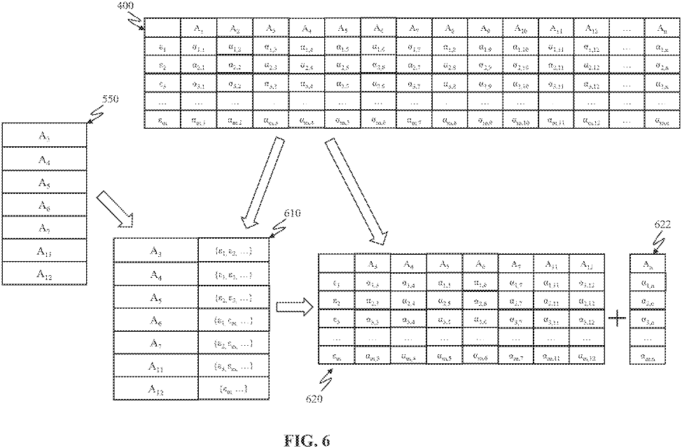

An exemplary analysis class is shown, for example, in FIG. 6. As shown, the analysis class comprises the data-event attributes A₃, A₄, A₅, A₆, A₇, A₁₁, and A₁₂ of the summary class. Moreover, each of the data-event attributes is associated, via the analysis class, with the indexed data-events ɛₘ - i.e., those data-events ɛₘ having attribute values for the summary class data-event attributes.

It will be understood that the analysis class shown in FIG. 6 is highly simplified for ease of illustrating the principles of the system described herein. In actual operation, the analysis class is contemplated as a “big-data” class, such that the analysis class may include several hundred-thousands of data-event attributes Aₙ and indexed data-events ɛₘ.

The data-event mapping module may further generate an index class 620. The index class may associate, for each indexed data-event, the attribute values for all the event-data attributes in the analysis class. Accordingly, the data-mapping module may parse the attribute values of the indexed data-events, so as to populate the index class.

An exemplary index class is shown, for example, in FIG. 6. As shown, the index class comprises the attribute values α_{m,n} of each indexed data-event ɛₘ for each data-event attribute Aₙ of the analysis class. In other words, the index class may be thought of as linking each indexed data-event ɛₘ to each data-event attribute Aₙ of the analysis class via the corresponding attribute values a_{m,n} of the indexed data-event ɛₘ for that data-event attribute Aₙ.

In some embodiments, the data-event mapping module may further supplement the index class according to one or more additional data-event attributes 622 derived from the parsed attribute values of the indexed data-events.

In particular, the data-event mapping module may identify one or more attribute values a_{m,n} that repeat among the indexed data-events, and for which the index class does not currently include the corresponding data-event attribute. For example, the attribute values α_{1,1}, a_{2,1}, and a_{3,1}, may repeat among the data-events ε₁, ε₂, ε₃ - i.e., the attribute values may be the same.

The data-event mapping module may, in response to such identification, supplement the index class by adding the data-event attribute corresponding to the repeating attribute value. The data-event mapping module may further populate the index class so as to accordingly include, for each indexed data-event, the attribute value corresponding to the added data-event attribute.

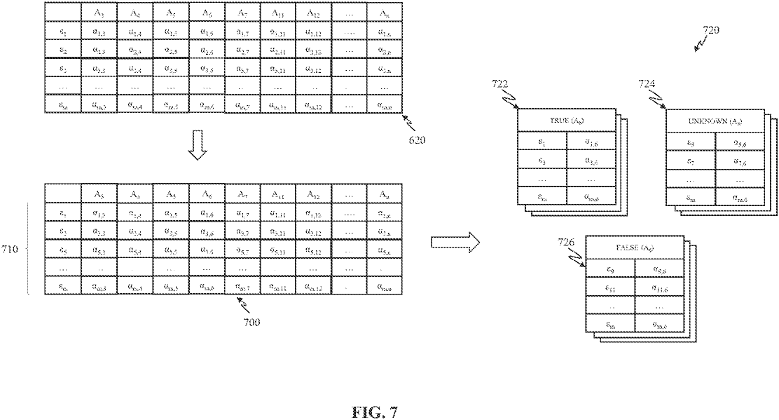

The exemplary index class, as supplemented with the additional data-event attributes 622 is shown, for example, in FIG. 7. As is shown, the index class includes the data-event attributes A₃, A₄, A₅, A₆, A₇, A₁₁, A₁₂, and also additional data-event attribute Aₙ, as well as corresponding attribute values for each of the indexed data-events.

The outlier determination module may be configured to identify a set of outlier data-events 710 from among the indexed data-events. The outlier data-events may be those indexed data-events whose attribute values a_{m,n} satisfy the parameters Pₙ of the linkset.

Accordingly, the outlier determination module may analyze the attribute values of the indexed data-events to determine whether the attribute values a_{m,n} satisfy the linkset parameters Pₙ. For example, the parameter P₁ may require that the attribute value α_{m,12} for data-event attribute A₁₂ (e.g., CHARGE_AMT) be in excess of some threshold (e.g., $2,000).

The outlier determination module may further generate a detail class 700, which may associate, for each of the outlier data-events, the attribute values for all the event-data attributes in the index class. In other words, the detail class is effectively the index class, but excluding the data-events whose attribute values α_{m,n} do not satisfy the parameters Pₙ of the linkset.

An exemplary detail class is shown, for example, in FIG. 7. As shown, the detail class includes the attribute values a_{m,n} of each outlier data-event ɛₘ for each data-event attribute Aₙ of the index class. The detail class may be instantiated in the in-memory neural network.

The neutrosophic processing module may neutrosophically analyze outlier data-event scenarios according to the rules Rₙ of the tailored linkset, so as to determine whether the outlier data-event scenarios are likely caused by the potential causes Cₙ defined by the tailored linkset.

Accordingly, the neutrosophic processing module may generate a computed class 800 from the outlier data-events of the detail class. In particular, the neutrosophic processing module may apply the rules Rₙ to the outlier-data events on a per summary class data-event attribute basis, so as to determine a truth category membership, which truth categories may be defined by the respective rules to determine whether correlation is suggestive of causation, is indeterminate of causation, or is not suggestive of causation — in a neutrosophic analysis sense.

For example, the rule R₁, as applied with respect to the data-event attribute Aₙ, may cause the neutrosophic processing module to evaluate the outlier data-events ɛₘ to identify those reoccurring attribute values a_{m,n} with occurrence rates greater than or equal to 75%. Those reoccurring attribute values a_{m,n} that satisfy the rule R₁ may be assigned to a TRUE truth category 722, indicating that the rule has determined a level of correlation with the proposed cause (e.g., fraud) that is suggestive of causation.

Similarly, the rule R₂, as applied with respect to the data-event attribute Aₙ, may cause the neutrosophic processing module to evaluate the outlier data-events ɛₘ to identify those reoccurring attribute values a_{m,n} with occurrence rates between 25%-74%. Those reoccurring attribute values a_{m,n} that satisfy the rule R₂ may be assigned to an UNKNOWN truth category 724, indicating that the rule has determined a level of correlation with the proposed cause (e.g., fraud) that is indeterminate of causation.

Likewise, the rule R₃, as applied with respect to the data-event attribute Aₙ, may cause the neutrosophic processing module to evaluate the outlier data-events ɛₘ to identify those reoccurring attribute values α_{m,n} with occurrence rates less than 25%. Those reoccurring attribute values a_{m,n} that satisfy the rule R₃ may be assigned to a FALSE truth category 726, indicating that the rule has determined a level of correlation with the proposed cause (e.g., fraud) that is not suggestive of causation.

It will be understood that other thresholds and/or rules may be used to determine truth category membership without departing from the principles of the invention.

FIG. 7 schematically illustrates exemplary truth categories 722, 724, 726. As can be seen, the truth categories may associate, for each truth category, the reoccurring attribute values a_{m,n} that satisfies the corresponding rule Rₙ with its corresponding data-event attribute Aₙ and outlier data-event ɛₘ.

For example, continuing with the previous example rules R₁, R₂, and R₃ and data-event attribute A₆ of POS_DESCR, the TRUE truth category indicates that the attribute values (e.g., α₁,₆, α₃,₆, etc.) are the same value (e.g., PATIENT HOME) for at least 75% of the outlier data-events. Similarly, the UNKNOWN category indicates that the attribute values (e.g., a₅,₆, α₇,₆, etc.) are the same value (e.g., EMERGENCY ROOM) for between 25%-74% of the outlier data-events. And, the FALSE category indicates that the attribute values (e.g., a₉,₆, a₁₁,₆, etc.) are the same value, e.g. (URGENT CARE) for less than 25% of the outlier data-events.

While only one exemplary attribute value is expressly described for each truth category, it is expressly contemplated that a plurality of attribute values may qualify for each of the truth categories. Thus, the truth category for the associated data-event attribute may include a first set of data-events having a first common attribute value for the associated data-event attribute, as well as a second set of data-events having a second common attribute value for the given data-event attribute. Moreover, while only the data-event attribute A₆ of POS_DESCR is shown, it is expressly contemplated that the truth category membership be determined for each of the summary class data-event attributes. In other words, truth category membership is also preferably determined for data-event attributes A₃, A₄, A₅, A₇, A₁₁, and A₁₂.

The neutrosophic processing module may further generate the computed class 800, based on the determined truth category membership 722, 724, 726, and the detail class 700.

In particular, the computed class may associate, for each of the outlier data-events identified from one or more of the truth categories (e.g., the TRUE category 722 and the UNKNOWN category 724), with the attribute values for all the event-data attributes in the detail class. In other words, the computed class is effectively the detail class, but excluding the outlier data-events that do fall within the TRUE or UNKNOWN truth categories for at least one of the detail class event-data attributes.

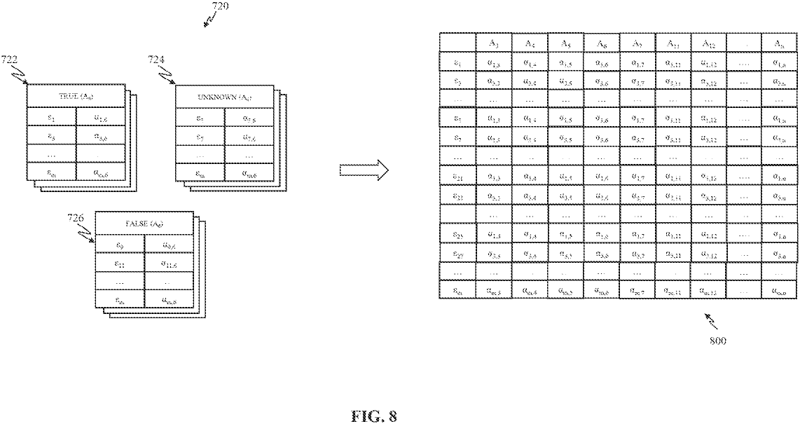

FIG. 8 schematically illustrates an exemplary computed class 800. As can be seen, the computed class includes all of the outlier data-events that, for at least one of the detail class event-data attributes, fall within either the TRUE or UNKNOWN truth categories. The computed class therefore represents the data-event scenarios for which there is some level of correlation with the proposed cause (e.g., fraud) that is suggestive of causation.

The neutrosophic processing module may be further configured to utilize multi-level regression analysis techniques to further neutrosophically analyze the outlier data-event scenarios present in the computed class 800.

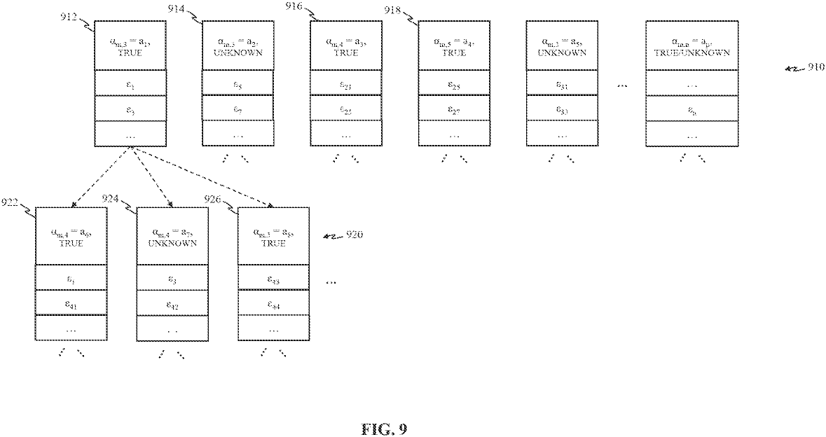

Accordingly, the neutrosophic processing module may identify and/or determine one or more first level outlier data-event scenarios 910 for each of the computed class data-event attributes. FIG. 9 schematically illustrates exemplary first level data-event outlier scenarios 910 for data-event attributes A₃, A₄, A₅, etc.

As previously discussed, data-event scenarios are defined by common attribute values among the set of data-events belonging to the data-event scenario. For example, the outlier data-event scenarios may be defined each as a set of common attribute values {aₚ, a_{q}, aᵣ, ... }, where each of the common attribute values is for a different data-event attribute. Each outlier data-event scenario may therefore represent each combination and permutation of possible common attribute values within the data-set of the computed class.

Moreover, the first level outlier data event-scenarios may correspond to outlier data-event scenarios where only one data-event attributes Aₙ is considered for the outlier data-event scenario. For example, as shown in FIG. 9, the first level outlier data-event scenario 912 represents the set of data-events whose attribute values for data-event attribute A₃ are the common attribute value α₁. Further, the first level outlier data-event scenario 914 represents the set of data-events whose attribute values for data-event attribute A₃ are the common attribute value α₂. Still further, the first level outlier data-event scenario 916 represents the set of data-events whose attribute values for data-event attribute A₄ are the common attribute value α₃. And, the first level outlier data-event scenario 918 represents the set of data-events whose attribute values for data-event attribute A₅ are the common attribute value α₄. The first level outlier data-event scenarios are preferably identified and/or determined for each common attribute value of each data-event attribute.

In accordance with the regression analysis, the neutrosophic processing module may further identify and/or determine one or more next level outlier data-event scenarios 920 for each of the computed class data-event attributes. Each of the next level outlier data-event scenarios may be a sub-scenario of a particular first-level outlier data-event scenario, thus establishing a unique scenario hierarchy of sorts, where each level of the hierarchy corresponds to another common attribute value of another data-event attribute. Moreover, each sub-scenario considers one or more other of the computed class data-event attributes not previously considered in the hierarchy. It will be understood that several such scenario hierarchies may be identified and/or determined, with each unique scenario hierarchy branching out from one of the first level outlier data-event scenarios.

For example, as shown in FIG. 9, the next level outlier data-event scenario 921 represents the set of data-events whose attribute values for data-event attribute A₃ are the common attribute value α₁, and whose attribute values for data-event attribute A₄ are the common attribute value α₆. Further, the next level outlier data-event scenario 924 represents the set of data-events whose attribute values for data-event attribute A₃ are the common attribute value α₁, and whose attribute values for data-event attribute A₄ are the common attribute value α₇. And, the next level outlier data-event scenario 926 represents the set of data-events whose attribute values for data-event attribute A₃ are the common attribute value α₁, and whose attribute values for data-event attribute A₅ are the common attribute value α₈. The next level outlier data-event scenarios are preferably identified and/or determined for each common attribute value of each other data-event attribute of the computed that has not previously been considered in the particular scenario hierarchy.

The neutrosophic processing module may continue to similarly identify and/or determine further next level outlier data-event scenarios, which may be further sub-scenarios considering further data-event attributes, such that each represented outlier data-event scenario and subs-scenario may be identified and/or determined. Thus, a plurality of unique multi-level outlier data-event scenarios may be identified and/or determined, which together represent all possible outlier data-event scenarios implicated by the computed class.

The neutrosophic processing module may further be configured to analyze the plurality of unique multi-level outlier data-event scenarios, so as to identify one or more systemic occurrences of data-event scenarios, via consideration of the outlier data-event scenarios’ truth category membership. In other words, the neutrosophic processing module may consider that some data-event scenario occurs, either independently or as a sub-scenario of higher level outlier data-event scenarios, at an occurrence rate that suggests causality with respect to the potential cause.

For example, the first level outlier data-event scenario may be a scenario where the outlier data-events (i.e., those data-events with CHARGE_AMT > $2,000) have a common attribute value of PATIENT HOME for the data-event attribute of POS_DESC, and it may be identified that such common attribute value occurs in over 25% (i.e., TRUE and UNKNOWN truth membership) of the outlier data-events. The next level outlier data-event scenario may further limit consideration to those outlier data-events that also have the common attribute value of HEALTHSMART RX for the data-event attribute of PROV _NAME, and it may be identified that such common attribute value occurs in over 75% (i.e., TRUE truth membership) of the outlier data-events that also meet the first-level outlier data-event scenario (i.e., also have POS_DESC as PATIENT HOME).

Accordingly, the multi-level data-event scenario indicates that, in the context of the potential cause of fee-for-service insurance fraud, over 75% of charge amounts over $2,000 were made where the point-of-service was the patient’s home — and that, of those, more than 75% were from the same provider. In other words, the multi-level data-event scenario is systemic in its occurrence.

The neutrosophic processing module may be configured to determine, from discovering such systemic occurrences of multi-level data-event scenarios, whether such systemic multi-level data-event scenarios, on a case-by-case basis, are likely caused by the potential cause. In other words, the multi-level data-event scenarios are neutrosophically analyzed so as to determine which scenarios are neutrosophic independent variables causally associated with the neutrosophic dependent variables of the potential causes. Such analysis may be done in parallel for all multi-level data-event scenarios, or individually. Other multi-level data-event scenario can further reinforce the determination.

The system is accordingly configured to determine outlier scenarios that are likely caused by the potential cause, which causal connection would not be otherwise recognized by current artificial intelligences.

The reporting module 260 may be configured to generate a causality report, based on the outlier scenarios determined as likely caused by the potential cause. The causality report may, at minimum, identify the potential causes for which likely causality has been determined.

The causality report may further be an interactive report, which includes the ability for a user, via a GUI, to navigate the scenario hierarchies. The interactive report may further not only identify the outlier data-event scenarios determined as likely caused by the potential cause, but may also identify how many data-events (e.g., 1.36e+6) are contained within each outlier data-event scenario identified. The causality report also may identify additional evidence supporting the causal determination, such as identifying other multi-level data-event scenarios that reinforce the determination.

Further discussion of details and aspects of the invention are provided in the Appendix A, filed herewith, which is hereby incorporated by reference in its entirety.

It is to be understood that the various components of the processes described above, could occur in a different order or even concurrently. It should also be understood that various embodiments of the inventions may include all or just some of the components described above. Thus, the processes are provided for better understanding of the embodiments, but the specific ordering of the components of the processes are not intended to be limiting unless otherwise described so.

It is to be understood that the above description is intended to be illustrative, and not restrictive. For example, the above-described embodiments may be used in combination with each other. As another example, the above-described processes include a series of actions which may not be performed in the particular order depicted in the drawings. Rather, the various actions may occur in a different order, or even simultaneously. Many other embodiments will be apparent to those of skill in the art upon reviewing the above description.

What is claimed:

1. A method for automatically detecting causes of outlier data-event scenarios, the method comprising:
receiving source data reflecting data-events, wherein the source data comprises data-event attributes and corresponding attribute values characterizing the data-events;
receiving user-intent data, wherein the user-intent data identifies potential causes and a set of parameters corresponding outlier data event scenarios for consideration;
instantiate a plurality of linksets of an ontological model in an in-memory neural network based on the user-intent data, the ontological model, and the source data,
wherein the instantiated linksets comprises a tailored array of interconnected index tables that defines the ontological relationship between the potential causes, the set of parameters, data-event attributes corresponding to the set of parameters, and neutrosophic rules corresponding to the potential causes and the set of parameters;
indexing the data-events of the source data so as to generate an index class of indexed data-events, wherein the index class links each indexed data-event to the instantiated data-event attributes corresponding to the instantiated parameters via corresponding attribute values of the indexed data-events;
supplementing the index class with additional data-event attributes corresponding to repeating attribute values of the indexed data-events; and
neutrosophically analyzing the index class according to the neutrosophic rules of the instantiated linkset, so as to thereby detect whether outlier data-event scenarios are likely caused by one or more of the potential causes defined by the instantiated linkset, wherein the outlier data-event scenarios are defined by respective sets of data-event attributes.

2. The method of claim 1, wherein the neutrosophic rules consider attribute value reoccurrence rates for truth membership with respect to the potential causes.

3. The method of claim 1, further comprising:
generating the ontological model from linkset data, wherein the linkset data identifies potential causes of outlier data-event scenarios and, for each potential cause, identifies one or more data-event scenarios, and further identifies one or more rules for determining which of the potential causes are likely causes of the outlier data-event scenarios.

4. The method of claim 1, wherein the index class is supplemented with additional data-event attributes that are fuzzy-logic identified data-event attributes potentially indicative of potential causes.

5. The method of claim 1, further comprising:
determining a set of outlier data-events from among the indexed data-events based on the attribute values of the indexed data-events and parameters of the instantiated linkset, so as to generate a detail class reflecting the indexed data-events whose attribute values satisfy the instantiated parameters,
wherein neutrosophically analyzing the index class includes neutrosophically analyzing the set of outlier data-events via the detail class.

6. The method of claim 1,
wherein the potential causes are neutrosophically dependent variables, and
wherein the neutrosophic analysis determines which data-event attributes, if any, are neutrosophically independent variables with respect to each of the potential causes.

7. The method of claim 1, further comprising:
generating a causality report that identifies the outlier data-event scenarios detected as likely caused by one or more of the potential causes.
